(19) United States
(12) Patent Application Publication
(10) Pub. No.: US 2017/0060571 A1
(43) Pub. Date: Mar. 2, 2017

(54) SYSTEM AND METHOD FOR MASKING COMPLEXITY IN A HETEROGENEOUS DEVELOPMENT ENVIRONMENT

(71) Applicants: Kelsey L. Bruso, Roseville, MN (US); Eugene J. Gretter, Roseville, MN (US); Alan Hood, Coon Rapids, MN (US)

(72) Inventors: Kelsey L. Bruso, Roseville, MN (US); Eugene J. Gretter, Roseville, MN (US); Alan Hood, Coon Rapids, MN (US)

(73) Assignee: UNISYS CORPORATION, Blue Bell, PA (US)

(21) Appl. No.: 14/840,370

(22) Filed: Aug. 31, 2015

(51) Int. Cl. G06F 9/44; G06F 21/62

(52) U.S. Cl. CPC G06F 8/70; G06F 21/6218

(57) ABSTRACT

A system and method for masking the complexity of developing software for a heterogeneous target execution environment may be established by configuring an integrated development environment to perform certain masking mechanisms. For example, the integrated development environment used to develop a background process may be used to create a background process-file on the target execution environment. The integrated development environment may further be configured to synchronously connect with an agent on the target execution environment, allowing the agent to initiate the background process using the integrated development environment user credentials. Additionally, the integrated development environment may be configured to monitor completion of the background process execution on the target execution environment, and to return the output from the background process after completion to the integrated development environment user.

### FIELD OF THE DISCLOSURE

The instant disclosure relates to software environments. More specifically, this disclosure relates to dynamically masking the complexity in developing software for a heterogeneous target environment.

### BACKGROUND

Software developers can utilize integrated development environments (IDEs), to write code, compile the code for a target environment, combine the code with other compilation artifacts into an executable for the target environment, and run and test the executable. If the execution environment that hosts the IDE matches or is similar to the target execution environment, these actions can be performed easily, and often within the IDE itself. However, when the target execution environment has fundamentally different architecture, the compile, combine, and run actions must be performed on the target heterogeneous execution environment.

When the target execution environment has fundamentally different architecture from the execution environment hosting the IDE, the interaction between the IDE and the execution environment completing the compile, combine and run actions is complex. An intermediate session is often required to facilitate this interaction. With the use of an intermediate session, it is apparent to the user of the IDE that the actions are not being performed locally in the IDE environment, but rather are occurring in a heterogeneous execution environment. Further, use of an intermediate session may decrease control and security for the IDE user.

### SUMMARY

A system and method for masking the complexity of developing software using an IDE for a target execution environment that has fundamentally different architecture than the execution environment hosting the IDE may be created by configuring the IDE to perform certain masking mechanisms. For example, the IDE may be configured to create and populate a process-file associated with a background process on the target execution environment. The IDE may also be configured to synchronously connect with an agent on the target execution environment, passing the IDE user credentials to the agent, and allowing the agent to initiate the background process on the target execution environment. The IDE may additionally be configured to monitor completion of the background process on the target execution environment, and to return the output from the background process to the IDE. These masking mechanisms remove the need for an intermediate session, mask the complexity of developing software for a heterogeneous target environment, and provide more control and security for IDE users developing the software.

According to one embodiment of the invention, a method may include creating and populating, by a processor, with the use of an integrated development environment, a process-file for executing a background process on a target execution environment. The method may also include transferring, by the processor, control of the process-file to an agent on the target execution environment. The method may further include initiating, by the processor, the background process using credentials associated with the integrated development environment's user. The method may also include monitoring, by the processor, the target execution environment for completion of the background process. The method may further include returning, by the processor, one or more results of the background process and control of the process-file to the integrated development environment.

According to another embodiment, a computer program product may include a non-transitory computer readable medium comprising instructions which, when executed by a processor of a computing system, cause the processor to perform the steps of creating and populating, with the use of an integrated development environment, a process-file for executing a background process on a target execution environment. The medium may also include instructions which, when executed cause the processor to perform the steps of transferring control of the process-file to an agent on the target execution environment. The medium may further include instructions which, when executed by the processor, cause the processor to perform the steps of initiating the background process using credentials associated with the integrated development environment's user. The medium may also include instructions which, when executed by the processor, cause the processor to perform the steps of monitoring the target execution environment for completion of the background process. The medium may also include instructions which, when executed by the processor, cause the processor to perform the steps of returning one Or more results of the background process and control of the process-tile to the integrated development environment.

According to yet another embodiment, an apparatus may include a memory, and a processor coupled to the memory. The processor may be configured to execute the steps of creating and populating, with the use of an integrated development environment, a process-file for executing a background process on a target execution environment. The processor may also be configured to execute the steps of transferring control of the process-file to an agent on the target execution environment. The processor may further be configured to execute the steps of initiating the background process using credentials associated with the integrated development environment's user. The processor may also be configured to execute the steps of monitoring the target execution environment for completion of the background process. The processor may further be configured to execute the steps of returning one or more results of the background process and control of the process-file to the integrated development environment.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method for using an IDE to develop software for a heterogeneous target execution environment, according to one embodiment of the disclosure.

FIG. 2 is a flow chart illustrating a method for using an IDE to create and configure software for developing and executing a background process in a heterogeneous target execution environment, according to one embodiment of the disclosure.

FIG. 3 is a flow chart illustrating a method for using an IDE to create and configure software on a target execution environment to capture results from an executed background process, according to one embodiment of the disclosure.

FIG. 4 is a flow chart illustrating a method for using an IDE to create and configure software on a target execution environment for indicating when a background process is complete, according to one embodiment of the disclosure.

FIG. 5A is a flow chart for configuring an agent on the target execution environment, according to one embodiment of the disclosure.

FIG. 5B is a flow chart for sending a request to a software agent on a target execution environment for initiating a background process, according to one embodiment of the disclosure.

FIG. 6 illustrates software environments for developing software using an IDE, according to one embodiment of the disclosure.

FIG. 7 illustrates a computer system adapted according to certain embodiments of a server and/or a user interface device for implementing embodiments of the disclosure, according to one embodiment of the disclosure.

### DETAILED DESCRIPTION

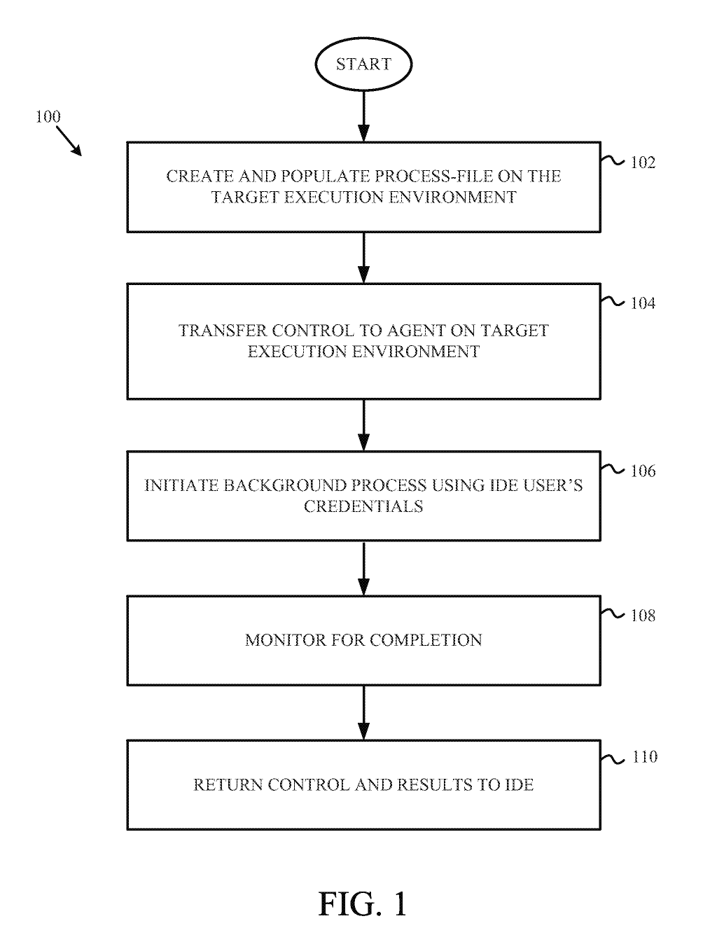

FIG. 1 is a flow chart illustrating a method for using an IDE to develop software for a heterogeneous target execution environment, according to one embodiment of the disclosure. The IDE may be, for example, a standard industry IDE, such as Eclipse or Microsoft™ Visual Studio™. The target execution environment may be, for example, the Unisys Dorado system. A method 100 may start at block 102 by creating and populating, by a processor, with the use of an IDE, a process-file for executing a background process on a target execution environment. The created background process-file may include code for a background process that was developed by the IDE user. The code may be written for execution in a target execution environment that may have fundamentally different architecture from the execution environment hosting the IDE. The code for the background process may be written to the background process-file in addition to control statements that compile the code and combine the code with other compilation artifacts into an executable for the target environment.

Once the process-file has been populated with the background process code and the control statements required to complete the background process, at block 104, the method may include transferring, by the processor, control of the process-file to an agent on the target execution environment. The agent may be located on the target execution environment for the purpose of interacting with the IDE to develop and test software like the background process. The agent may be a multithreaded program, with each thread being responsible for processing requests from various IDE clients to test software. At block 106, the method may include initiating, by the processor, the background process using credentials associated with the IDE's user. The IDE may be configured to synchronously connect with the agent on the target execution environment, passing the IDE user credentials to the agent. The agent may impersonate the IDE user and initiate the background process, using the IDE user credentials. The IDE user credentials assumed by the agent may be checked with user credentials stored in the target execution environment to only allow the agent to access files and other systems services located on the target execution environment that the IDE user credentials are authorized to access. This authentication for access provides enhanced security in the target execution environment.

At block 108, the method may include monitoring, by the processor, the target execution environment for completion of the background process. The IDE may be configured to monitor the background process to detect completion of the process. In one embodiment, the IDE may be configured with a maximum time that it will monitor for completion of the process. Once completion of the process is detected, at block 110, the method may include returning, by the processor, one or more results of the background process and control of the background process-file to the IDE. The IDE may be configured to facilitate return of the results of the background process to the IDE user after the IDE detects completion. The results may, for example, highlight any errors that occurred during compilation of the code for the background process, or may include messages generated during the background process. After the IDE regains control of the background process-file, the user may edit the code for the background process, and then repeat method 100 as many times as needed until satisfied with the results. This method 100 may mask the complexity of developing code for a heterogeneous target execution environment, and make it appear to the IDE user as if the background file is being developed and run local to the IDE, Additionally, this method may provide more security and control for an IDE user developing software for a heterogeneous target execution environment.

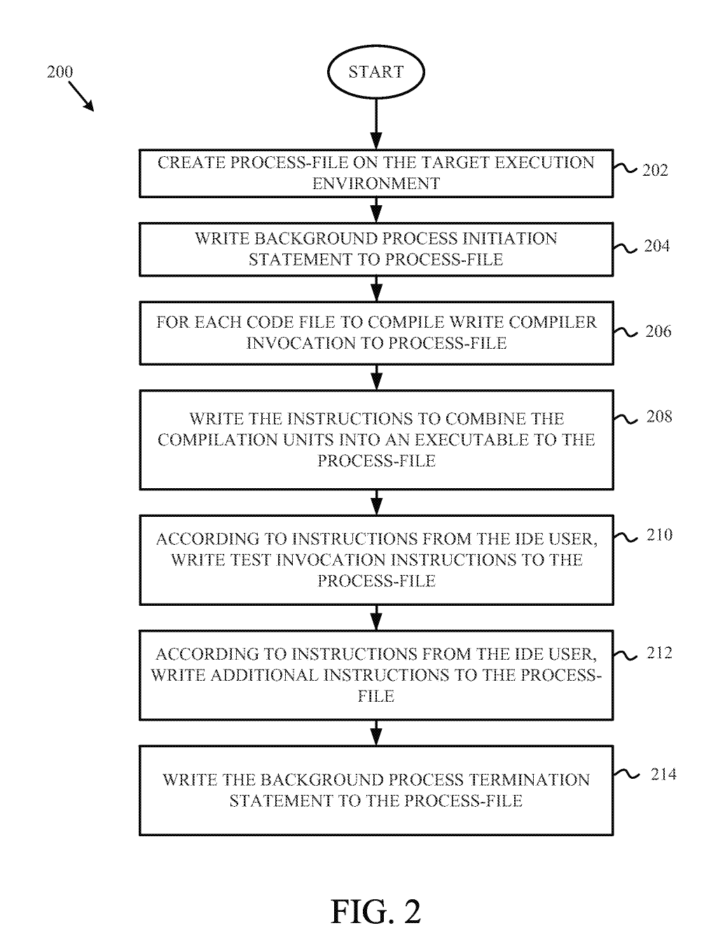

FIG. 2 is a flow chart illustrating a method for using an IDE to create and configure software for developing and executing a background process in a heterogeneous target execution environment, according to one embodiment of the disclosure. A background process-file may be created and configured in a target execution environment using method 200, consistent with the software development method 100 shown in FIG. 1 above. The method 200 may begin at block 202 with using an IDE to create a process-file on the target execution environment. The process-file may be created using the IDE user credentials to allow read and write access to files on the target execution environment. The process-file may be created with the code developed by the IDE user for a background process. At block 204, the method may include using an IDE to write a background process initiation statement to the process-file. For example, when configuring the background process-file on a Unisys Dorado system, the Executive Control Language (ECL) statement @RUN may be written to the process-file. The initiation statement may describe, for example, attributes for background process execution including executing priority, account number for charging for the resources consumed during the background process execution, and the file group (project-id) that the background process may access. The background process initiation statement may include default values, or values specified in the IDE configuration to alleviate the burden from the IDE user.

At block 206, the method may include using an IDE to write a compiler invocation to the process-file for each code file of the background process code to compile. Compiling code modules may require processing of copy elements, shared data structures, or database access mechanisms prior to compiling the code that uses them, and at block 206, these processing and compilation statements may be written to the process-file as necessary. At block 208, the method may include using an IDE to write instructions to combine the compilation units resulting from the compile statements at block 206 into an executable to the process-file. At block 210, the method may include using an ME to write test invocation instructions to the process-file according to instructions from the IDE user. The executable created using the instructions at block 208 may be tested using the IDE-user supplied testing statements written to the process-file at block 210.

At block 212, the method may include using an IDE to write additional instructions to the process-file according to instructions supplied by the IDE user. An IDE user skilled in the target execution environment may want to include instructions in addition to the standard code, compile, combine, and execute actions. The IDE may be configured to allow the skilled user to include such statements into the process-file at block 212 to be processed as part of the background processing on the target execution environment. At block 214, the method may include using an IDE to write a background process termination statement to the process-file to complete the processing. For example, when configuring the background process-file on a Unisys Dorado system, the Executive Control Language (ECL) statement @FIN may be written to the process-file. If during the handling of the process-file by the target execution environment, the background process does not execute the termination statement, the background process will indicate an error to the IDE.

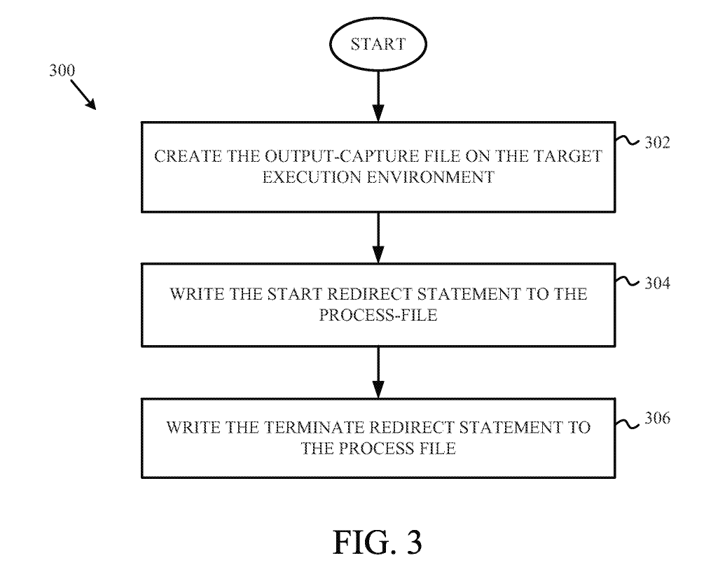

FIG. 3 is a flow chart illustrating a method for using an IDE to create and configure software on a target execution environment to capture results from an executed background process, according to one embodiment of the disclosure. Software may be created and configured in a target execution environment using method 300, consistent with the software development method 100 shown in FIG. 1 above, to capture results from an executed background process. The method 300 may begin at block 302 with using an IDE to create an output-capture file on the target execution environment. The output-capture file may be created using the I DE user credentials on the target execution environment to allow read and write access to files on the target execution environment. The output-capture file allows for the output of an executed process to be gathered, so that it can be returned to the IDE user in a usable manner.

At block 304, the method may include using an IDE to write a start output redirect statement to a background process-file on the target execution environment. For example, when configuring software on a Unisys Dorado system, the Executive Control Language (ECL) statement @BRKPT may be written to the process-file. With this command, the operating system redirects dialogue that is captured from the executed background process to the output-capture file. At block 306, the method may include using an IDE to write a terminate redirect statement to the process-file to complete the redirection. For example, when configuring software on a Unisys Dorado system, another Executive Control Language (ECL) statement @BRKPT may be written to the process-file to terminate the output redirection. The terminate redirect statement may be written prior to writing the background process termination statement to the process-file, like at block 214 in FIG. 2. After the background process is executed, the output may be redirected to the output-capture file. The output-capture results may then be returned to the IDE from the output-capture file.

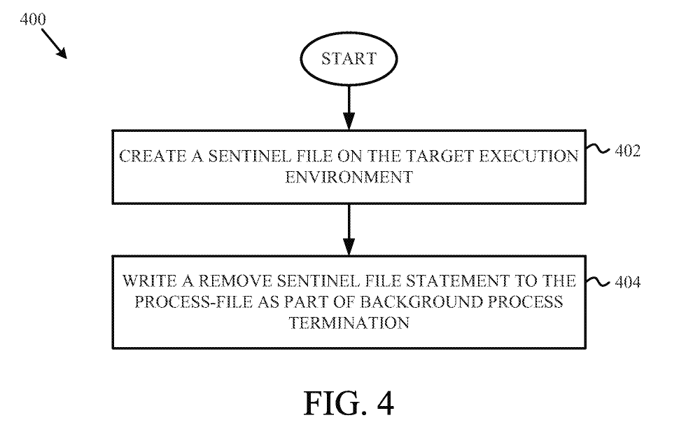

FIG. 4 is a flow chart illustrating a method for using an IDE to create and configure software on a target execution environment for indicating when a background process is complete, according to one embodiment of the disclosure. Software may be created and configured in a target execution environment using method 400, consistent with the software development method 100 shown in FIG. 1 above, to indicate when a background process completes. The method 400 may begin at block 402 with using an IDE to create a sentinel file on the target execution environment. At block 404, the method may include using an IDE to write a statement to the background process-file to delete the sentinel file as part of the background process termination at 214 in FIG. 2. With this command, the sentinel file will be deleted upon completion of the background process. The IDE may be configured to monitor the existence of the sentinel file to detect when the background process is completed. If the background process terminates abnormally before deleting the sentinel file, the IDE's sentinel monitor mechanism times out, and returns the time-out occurrence to the IDE user, asserting an abnormal termination of the background process. The IDE may additionally be configured with a timeout mechanism to return control of the process-file to the IDE should the background process fail to terminate, and the sentinel file fail to be deleted.

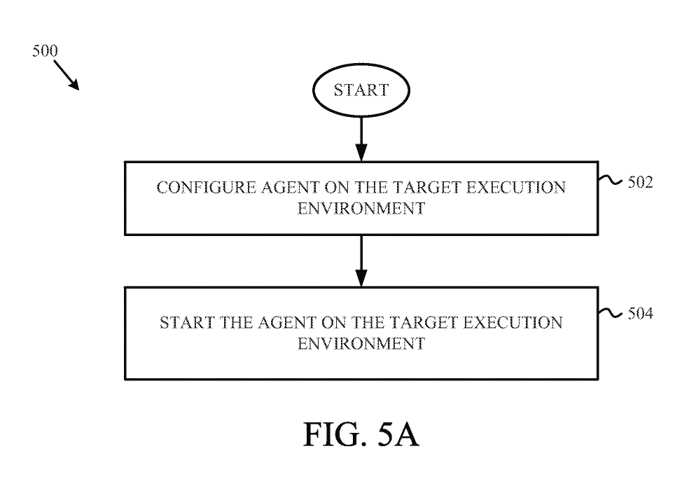

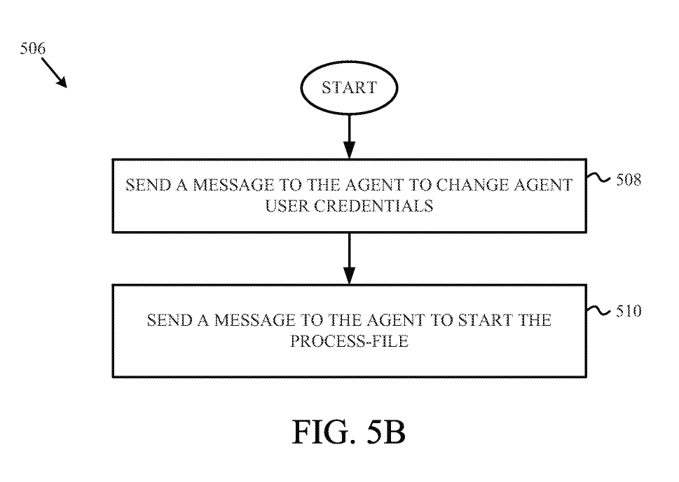

FIG. 5A is a flow chart for configuring an agent on the target execution environment, according to one embodiment of the disclosure. The agent coordinates requests from a plurality of IDEs and a plurality of IDE users. The software agent may be configured in accordance with method 500 in a target execution environment to initiate a background process in the target execution environment, consistent with the software development method 100 in FIG. 1 above. At block 502, the agent is configured according to the requirements of the target execution environment. According to one embodiment, the agent may be configured according to the requirements of the target execution environment by a system administrator, while in another embodiment the agent may be configured according to the requirements of the target execution environment automatically without human intervention. In one embodiment, configuring the agent in accordance with requirements of the target execution environment may include configuring the agent to allow it to impersonate a user in order to initiate the background process-file. Typically, impersonation is a privileged operating system capability. For example, when initiating a background process-file on a Unisys Dorado system, altering the current credentials of the software agent on the system to initiate a background process on the system requires use of the privileged operating system service SEC$SWITCH$. Thus, the agent in the Unisys Dorado system would need to be configured and authorized to execute the privileged operating system service SEC$SWITCH. In another embodiment, configuring the agent in accordance with requirements of the target execution environment may include configuring the agent to communicate over connections having a particular security level.

The system administrator must also configure the agent to accept requests from the plurality of IDEs and IDE users. In one embodiment the agent is configured to accept requests using a messaging mechanism that sends messages via a connection established for receiving and sending messages. Once configured, the system administrator starts the agent 504 on the target system and it accepts request messages from the plurality of IDEs and IDE users.

FIG. 5B is a flow chart for sending a request to a software agent on a target execution environment for initiating a background process, according to one embodiment of the disclosure. The request 506 may begin at block 508 with the IDE sending a message to the software agent to instruct the agent to use the IDE user's credentials. The user credentials that are used to initiate a background process control the privilege of the background process. The credentials of the IDE user that created a background process may be needed to have access to the files and system services required to initiate the background process. Thus, for a software agent on the target execution environment to initiate a background process created by an IDE user, the agent may need to assume the user credentials of the IDE user. The IDE user credentials may also be needed to initiate the change in the agent's user credentials to allow assumption of the IDE user credentials.

At block 510, the IDE may continue with sending a start statement message to the software agent in order to initiate a background process on behalf of the IDE. For example, when initiating the background process on a Unisys Dorado system, the Executive Control Language (ECL) statement @START may be sent to the software agent. The start statement written to the agent may reference the background process-file as the object containing the instructions for the background process to be initiated by the agent. To perform the start statement, the agent may have to change its persona using the mechanism described in 502 to use the credentials of the IDE user in message 508 to gain access to the referenced process-file, and to have the background process execute under the IDE user credentials.

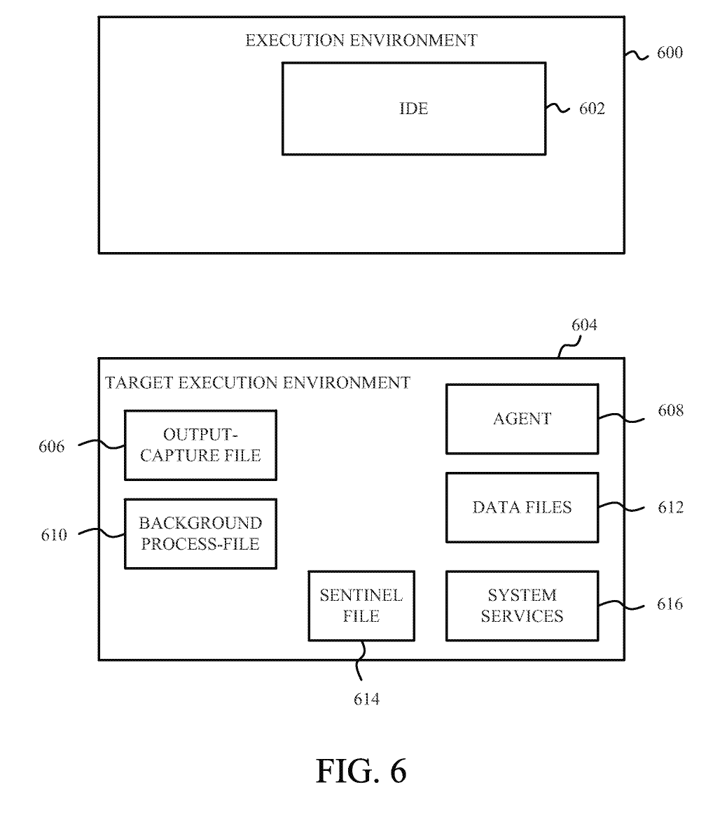

FIG. 6 illustrates software environments for developing software using an IDE, according to one embodiment of the disclosure. For example, the methods and software described with respect to FIGS. 1-5 may be executed within the FIG. 6 software environments. An IDE 602 may run on a software execution environment 600 that has a fundamentally different architecture from a target execution environment 604. Using the IDE 602, a user may develop software for a background process that executes in the target execution environment 604. Using the IDE 602, the user may create a background process-file 610, an output-capture file 606, and a sentinel file 614 on the target execution environment 604. Also using the IDE 602, execution instructions may be written to the background process-file 610, the output-capture file 606, and the sentinel file 614. There may be an agent 608 in the target execution environment 604 that facilitates interactions between the IDE 602 and the target execution environment 604 to mask the complexities of developing software for a target execution environment 604 that has fundamentally different architecture than the execution environment 600 hosting the IDE 602.

There may be user credentials associated with the IDE user. User credentials that are authorized to access data files 612 and other system services 616 in the target execution environment 604 may be stored in the target execution environment 604. The IDE user credentials may be passed to the agent 608 on the target execution environment 604 to allow the agent 608 to assume the IDE user credentials. This allows the agent 608 on the target execution environment 604 to impersonate the IDE user. The IDE user credentials may be checked with the user credentials stored in the target execution environment 604, to determine if the IDE user is authorized to access certain data files 612 and other system services 616 on the target execution environment 604 needed to execute the background process.

The IDE 602 may monitor the existence of the sentinel tile 614 during the background process to detect when the background process terminates. Upon detection of deletion of the sentinel file 614, which indicates completion of the background process, the IDE 602 reads the output-capture from output-capture file 606 and returns the contents to the IDE user. The output-capture may be developed when the results from the completed background process are redirected to the output-capture file 606. The output-capture contents may be returned to the IDE 602 as a stream object.

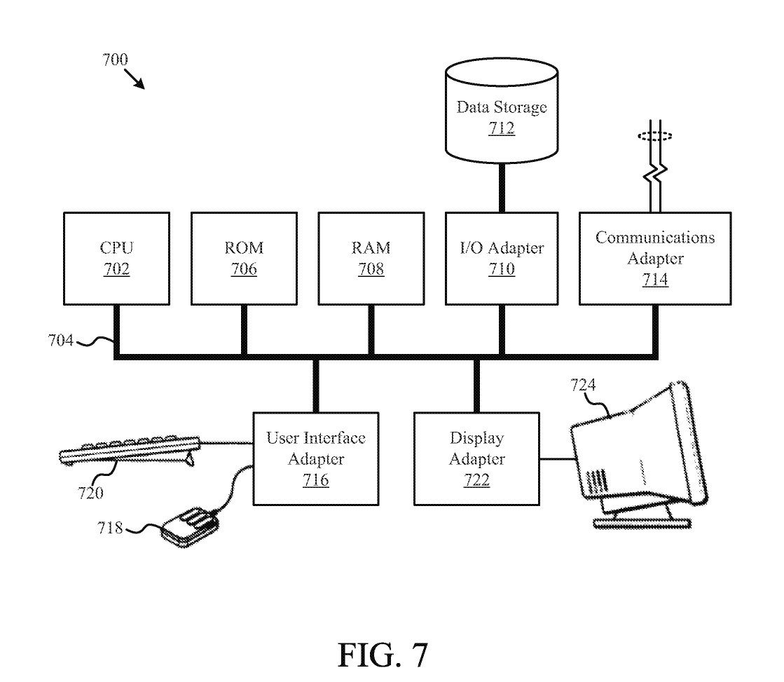

FIG. 7 illustrates a computer system 700 adapted according to certain embodiments of a server and/or a user interface device for implementing embodiments of the disclosure, according to one embodiment of the disclosure. For example, computer system 700 may implement each of the embodiments illustrated in FIGS. 1-6. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations described herein. The CPU 702 may execute the various logical instructions according to the present embodiments.

The computer system 700 may also include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to a network, which may be one or more of a LAN, WAN, and/or the Internet. The user interface adapter 716 couples user input devices, such as a keyboard 720, a pointing device 718, and/or a touch screen (not shown) to the computer system 700. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of a server and/or the user interface device 710. For example, any suitable processor-based device may be utilized. including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, in some embodiments, aspects of the computer system 700 may be virtualized for access by multiple users and/or applications.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
creating and populating, by a processor, with the use of an integrated development environment, a process-file for executing a background process on a target execution environment;
transferring, by the processor, control of the process-file to an agent on the target execution environment;
initiating, by the processor, the background process using credentials associated with the integrated development environment's user;
monitoring, by the processor, the target execution environment for completion of the background process; and
returning, by the processor, one or more results of the background process and control of the process-file to the integrated development environment.

2. The method of claim 1, in which the target execution environment has fundamentally different architecture than the execution environment hosting the integrated development environment.

3. The method of claim 1, in which one or more user credentials and corresponding privileges for each of the one or more user credentials, authorizing user access to one or more files or system services on the target execution environment, are stored in the target execution environment.

4. The method of claim 1, in which completion of the background process is monitored by the integrated development environment using the existence of a sentinel file in the target execution environment.

5. The method of claim 1, further comprising creating, by the processor, with the use of the integrated development environment, an output-capture file in the target execution environment to capture the one or more results of the background process.

6. The method of claim 1, in which the process-file, after population, includes a background process initiation statement, a compile statement, a combine statement, and a background process termination statement.

7. The method of claim 6, in which the process-file, after population, further includes one or more control statements supplied by the integrated development environment user.

8. A computer program product, comprising:
a non-transitory computer readable medium comprising code to perform the steps of:
creating and populating, with the use of an integrated development environment, a process-file for executing a background process on a target execution environment;
transferring control of the process-file to an agent on the target execution environment;
initiating the background process using credentials associated with the integrated development environment's user;
monitoring the target execution environment for completion of the background process; and
returning one or more results of the background process and control of the process-file to the integrated development environment.

9. The computer program product of claim 8, in which the target execution environment has fundamentally different architecture than the execution environment hosting the integrated development environment.

10. The computer program product of claim 8, in which one or more user credentials and corresponding privileges for each of the one or more user credentials, authorizing user access to one or more files or system services on the target execution environment, are stored in the target execution environment.

11. The computer program product of claim 8, in which completion of the background process is monitored by the integrated development environment using the existence of a sentinel file in the target execution environment.

12. The computer program product of claim 8, in which the medium further comprises code to perform the step of:
creating, with the use of the integrated development environment, an output-capture file in the target execution environment to capture the one or more results of the background process.

13. The computer program product of claim 8, in which the process-file, after population, includes a background process initiation statement, a compile statement, a combine statement, and a background process termination statement.

14. The computer program product of claim 13, in which the process-file, after population, further includes one or more control statements supplied by the integrated development environment user.

15. An apparatus, comprising:
a memory; and
a processor coupled to the memory, the processor configured to execute the steps of:
creating and populating, with the use of an integrated development environment, a process-file for executing a background process on a target execution environment;
transferring control of the process-file to an agent on the target execution environment;
initiating the background process using credentials associated with the integrated development environment's user;
monitoring the target execution environment for completion of the background process; and
returning one or more results of the background process and control of the process-file to the integrated development environment.

16. The apparatus of claim 15, in which the target execution environment has fundamentally different architecture than the execution environment hosting the integrated development environment.

17. The apparatus of claim 15, in which one or more user credentials and corresponding privileges for each of the one or more user credentials, authorizing user access to one or more files or system services on the target execution environment, are stored in the target execution environment.

18. The apparatus of claim 15, in which completion of the background process is monitored by the integrated development environment using the existence of a sentinel file in the target execution environment.

19. The apparatus of claim 15, in which the processor is further configured to perform the step of:
creating, with the use of the integrated development environment, an output-capture file in the target execution environment to capture the one or more results of the background process.

20. The apparatus of claim 15, in which the process-file, after population, includes a background process initiation statement, a compile statement, a combine statement, and a background process termination statement.
